(19) United States
(12) Patent Application Publication
(10) Pub. No.: US 2025/0166554 A1
(43) Pub. Date: May 22, 2025

(54) VARIABLE-RESOLUTION DISPLAYS

(71) Applicant: X Display Company Technology Limited, Dublin (IE)

(72) Inventor: Ronald S. Cok, Rochester, NY (US)

(21) Appl. No.: 18/783,718

(22) Filed: Jul. 25, 2024

Related U.S. Application Data
(60) Provisional application No. 63/602,079, filed on Nov. 22, 2023.

(51) Int. Cl. G09G 3/32

(52) U.S. Cl. CPC G09G 3/32; G09G 2340/0407; G09G 2360/147

(57) ABSTRACT

A variable-resolution display comprises a display substrate and pixels disposed on the display substrate. Adjacent pixels are arranged over the display substrate with different spatial separations and at different spatial resolutions in one or two dimensions so that some portions of the display substrate have a greater spatial density of pixels and other portions of the display substrate have a lesser spatial density of pixels. The pixels are controlled to emit light in response to an unchanging image frame comprising image data for each pixel during a temporal frame period. An optical communication system comprises a variable-resolution display and a camera system comprising a digital camera, a memory, and a processor. The digital camera is disposed relative to the variable-resolution display such that the digital camera is operable to record an image displayed on the variable-resolution display and the processor is operable to process the recorded image.

### PRIORITY APPLICATION

The present application claims the benefit of U.S. Provisional Patent Application No. 63/602,079, filed on Nov. 22, 2023, the disclosure of which is hereby incorporated by reference herein in its entirety.

### CROSS REFERENCE TO RELATED APPLICATION

Reference is made to U.S. Patent Application No. 63/579,809 filed Aug. 30, 20123 entitled Optical Communication Systems with Displays by Cok et al., the disclosure of which is incorporated by reference herein in its entirety.

### TECHNICAL FIELD

The present disclosure relates generally to devices and methods for optical communication using a display.

### BACKGROUND

Optical systems are widely used to communicate between remote locations. Typical optical communication systems transmit optical signals from a laser to a photosensor over fiber optic cables. Some cables transmit a single signal through a single-mode fiber, other cables transmit multiple signals through a multi-mode fiber. Free-space optical systems transmit optical signals through free space (e.g., the atmosphere or outer space) with modulated laser light detected by a photosensor positioned within an optical path of the laser beam.

There is an increasing need for communication bandwidth and computation to support such applications as artificial intelligence, internet search fulfilment, and internet services requiring internet-accessible computers. To support this need, a large number of computers must compute and communicate and are often co-located in data centers. Conventionally, the computers in a data center communicate electronically, for example through wired ethernet connections. More recently, fiber optic cables optically connect computers within a single data center. However, the physical size of the fiber optic cables, the length of the fiber optic cables, and connections between the fiber optic elements and electronic equipment are becoming limitations on the computational capacity of connected computers within a data center.

There is a need, therefore, for improvements in devices and methods for optical communication.

### SUMMARY

The present disclosure provides, inter alia, architectures, structures, devices, and methods for improved optical communication using display pixels in a variable-resolution display. In embodiments, a variable-resolution display comprises a display substrate and display pixels disposed on the display substrate. Adjacent display pixels are arranged over the display substrate with different spatial separations and at different spatial resolutions in one or two dimensions so that some portions of the display substrate have a greater spatial density of display pixels and other portions of the display substrate have a lesser spatial density of display pixels. The display pixels are controlled to emit light in response to an unchanging image frame comprising image data for each display pixel during a temporal frame period. An optical communication system can comprise a variable-resolution display and a camera system comprising a digital camera, a memory, and a processor. The digital camera can be disposed relative to the variable-resolution display such that the digital camera is operable to record an image displayed on the variable-resolution display and the processor is operable to process the recorded image, for example to extract communicated data from the recorded image.

According to embodiments of the present disclosure, a variable-resolution display can comprise a display substrate and pixels (e.g., display pixels) disposed on the display substrate. The pixels can have a variable spatial resolution over the display substrate. The pixels can be controllable to emit light in response to an unchanging image frame comprising data for each of the pixels during a temporal frame period. In some embodiments, the pixels can comprise three or more pixels disposed in a direction (e.g., in a line) or five or more pixels disposed in two directions (e.g., orthogonal directions). The variable resolution can be a variable spatial resolution making a variable spatial resolution. The variable resolution can be in one direction or in multiple (e.g., two orthogonal) directions. The variable resolution can be a first fixed resolution in a first direction and a second fixed resolution different from the first fixed resolution in a second direction different from the first direction (e.g., an orthogonal direction). Thus, the pixel spatial resolution in a direction can vary.

The pixels can comprise three or more pixels in a direction or five or more pixels in two directions. The five or more pixels can have a variable spatial resolution over the display substrate along each of two orthogonal directions. All of the pixels in the two-dimensional arrangement of pixels can be controlled to emit light in response to an unchanging image frame comprising data for each pixel during a temporal frame period.

In embodiments, two adjacent pixels are separated by a first distance in a direction (or dimension) and two other adjacent pixels are separated by a second distance different from the first distance in the same direction (or same dimension). The pixels can be disposed in two orthogonal directions over the display substrate. In embodiments, two adjacent first ones of the pixels can be separated by a first distance in a first direction and two other adjacent first ones of the pixels can be separated by a second distance different from the first distance in the first direction. Two adjacent second ones of the pixels can be separated by a third distance in a second direction orthogonal to the first direction and two other adjacent second ones of the pixels can be separated by a fourth distance different from the third distance in the second direction.

According to embodiments of the present disclosure, a variable-resolution display comprises pixels that comprise a first pixel, a second pixel, and a third pixel. The first pixel and the second pixel can be adjacent and separated by a first distance in a first direction and the first pixel and the third pixel can be adjacent and separated by a second distance in a second direction parallel to the first direction (e.g., in a common line). The first distance can be less than the second distance (e.g., at least 20% less, at least 25%, at least 40%, at least 50% less, at least 60% less, or at least 75% less).

According to embodiments of the present disclosure, a variable-resolution display comprises pixels that comprise a first pixel, a second pixel, and a third pixel. The first pixel and the second pixel can be adjacent and separated by a first distance in a first direction. The first pixel and the third pixel can be adjacent and separated by a second distance in a second direction non-parallel (e.g., orthogonal) to the first direction, and the first distance can be less than the second distance (e.g., at least 20% less, at least 25%, at least 40%, at least 50% less, at least 60% less, or at least 75% less).

In some embodiments, successive adjacent pixels along at least one direction (e.g., one or two directions) are alternately separated by two different distances.

In some embodiments, pixels are arranged in mutually exclusive clusters of pixels. The pixels in each cluster of pixels can be controlled in common by a cluster controller. In some embodiments, fewer display pixels per unit area of the display substrate are disposed in a cluster of pixels than to an edge of the display substrate, fewer display pixels per unit area of the display substrate are disposed closer to a center in a first region of the display substrate than to an edge in a second region of the display substrate, more display pixels per unit area of the display substrate are disposed in a cluster of pixels than to an edge of the display substrate, or more display pixels per unit area of the display substrate are disposed closer to the center in the first region of the display substrate than to an edge in the second region of the display substrate.

According to some embodiments, fewer of the pixels per unit area of the display substrate are disposed in a first region than in a second region. In some embodiments, the first region is closer to a center of the display substrate than to an edge of the display substrate and the second region is closer to the edge of the display substrate than to a center of the display substrate (e.g., wherein the first region is at the center and the second region is at the edge). In some embodiments, the second region is at an edge of the display substrate and the first region is in a cluster of pixels away from the edge.

According to some embodiments, fewer of the pixels per unit area of the display substrate are disposed in a second region than in a first region. In some embodiments, the first region is closer to a center of the display substrate than to an edge of the display substrate and the second region is closer to the edge of the display substrate than to a center of the display substrate (e.g., wherein the first region is at the center and the second region is at the edge). In some embodiments, the second region is at an edge of the display substrate and the first region is in a cluster of pixels away from the edge.

Embodiments of the present disclosure can comprise a circuit disposed on the display substrate that is electrically connected to and controls two or more of the pixels. The circuit can control a pixel or a cluster of pixels. Some embodiments comprise multiple circuits. The display substrate can be a semiconductor substrate and the circuit(s) can be formed in or on and native to the semiconductor display substrate. The display substrate can be a non-semiconductor substrate and the circuit(s) can be thin-film circuit(s) formed in or on and native to the display substrate. The display substrate can be a non-semiconductor substrate and the circuit(s) can be integrated circuit(s) having circuit substrate(s) separate and independent from and non-native to (e.g., separate and independent from or having separate and independent substrates) the display substrate disposed on the display substrate using micro-transfer printing.

The circuit(s) can be disposed in or on an area or portion (e.g., in a region) of the display substrate having a lower spatial resolution of pixels than another different area or portion (e.g., a region) of the display substrate. Some embodiments comprise a plurality of circuits and each of the circuits can be exclusively electrically connected to and control an exclusive subset of the pixels, e.g., a cluster of pixels. The display substrate can have edges (e.g., two or more edges) or can have a rectangular shape (e.g., with four edges or four sides). Fewer of the display pixels per unit area of the display substrate can be disposed at one of the edges than at another of the edges of the display substrate.

Some embodiments of the present disclosure comprise a wire (an electrical conductor for transmitting electrical signals) disposed on the display substrate that extends from an edge of the display substrate to the circuit and is electrically connected to the circuit. In some embodiments, the edge of the display substrate has fewer display pixels per unit area of the display substrate than another edge of the display substrate, for example to spatially accommodate wires.

According to embodiments of the present disclosure, the pixels are monochrome pixels that emit a same color of light. In some embodiments, the spatial resolution is determined by the distance in a direction between two adjacent pixels that emit the same color of light or by the pitch of two adjacent pixels that emit the same color of light. In some embodiments, the pixels are color pixels comprising subpixels that each emit a different color of light. In some embodiments, the spatial resolution is determined by the distance between two adjacent subpixels that emit the same color of light or by the pitch of two adjacent pixels that emit the same color of light.

According to embodiments of the present disclosure, an optical communication system comprises a variable-resolution display and a digital camera system. The digital camera system can comprise a digital camera and a processor connected to the digital camera. The digital camera can be disposed relative to the variable-resolution display to receive light from the variable-resolution display so that the digital camera can be operable to record an image displayed on the variable-resolution display. The processor can be operable to process the recorded image. The digital camera system can comprise a memory connected to the processor. A digital map of locations of the pixels on the display substrate can be stored in the memory and used by the processor to process the recorded image and identify and segment pixels in the recorded image to find the value of the identified and segmented pixels.

According to embodiments of the present disclosure, a method of operating an optical communication system can comprise displaying an image with the pixels, recording the image with the camera, comparing the digital map to the recorded image with the processor to locate ones of the pixels in the recorded image, and extracting a value from each of the located ones of the pixels.

Embodiments of the present disclosure comprise a free-space optical communication system comprising a variable-resolution display.

Embodiments of the present disclosure provide improvements in devices and methods for optical communication using a display and digital camera.

### BRIEF DESCRIPTION OF THE DRAWINGS

The foregoing and other objects, aspects, features, and advantages of the present disclosure will become more apparent and better understood by referring to the following description taken in conjunction with the accompanying drawings, in which:

FIG. 1 is a schematic diagram of a variable-resolution display according to illustrative embodiments of the present disclosure;

FIG. 2 is a schematic diagram of a variable-resolution display according to illustrative embodiments of the present disclosure;

FIG. 3 is a schematic diagram of a variable-resolution display according to illustrative embodiments of the present disclosure;

FIG. 4A is a schematic diagram of monochrome pixels according to illustrative embodiments of the present disclosure;

FIG. 4B is a schematic diagram of color pixels comprising subpixels according to illustrative embodiments of the present disclosure;

FIG. 5A is a schematic diagram of a variable-resolution display with a bus connection showing an active-matrix color pixel detail and a passive-matrix color pixel detail according to illustrative embodiments of the present disclosure;

FIG. 5B is a schematic diagram of a variable-resolution display with multiple bus connections showing an active-matrix color pixel detail and a passive-matrix color pixel detail according to illustrative embodiments of the present disclosure;

FIG. 6A is a schematic cross section of a micro-transfer-printed horizontal micro-light-emitting diode according to illustrative embodiments of the present disclosure;

FIG. 6B is a schematic cross section of a micro-transfer-printed vertical micro-light-emitting diode according to illustrative embodiments of the present disclosure;

FIG. 6C is a schematic cross section of micro-transfer-printed pixel controller or cluster controller according to illustrative embodiments of the present disclosure;

FIG. 7 is a schematic diagram of an optical communication system comprising a variable-resolution display and a digital camera system according to illustrative embodiments of the present disclosure; and

FIG. 8 is a flow diagram of methods according to illustrative embodiments of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The figures are not necessarily drawn to scale.

### DETAILED DESCRIPTION OF CERTAIN EMBODIMENTS

Free-space optical communication systems can suffer from limited bandwidth because of a corresponding limitation in the number of communication channels and the data rate of each communication channel. Embodiments of the present disclosure provide, among other things, free-space communication systems with multiple channels providing increased bandwidth. For example, each pixel in a variable-resolution display can be a free-space optical communication channel detected by a digital camera. If each pixel is a monochrome pixel emitting a single color of light, each pixel can be a separate and individual free-space optical communication channel detected by a digital camera. If each pixel is a color pixel having multiple subpixels emitting different colors of light, each color subpixel can be a separate and individual free-space optical communication channel detected by a digital camera.

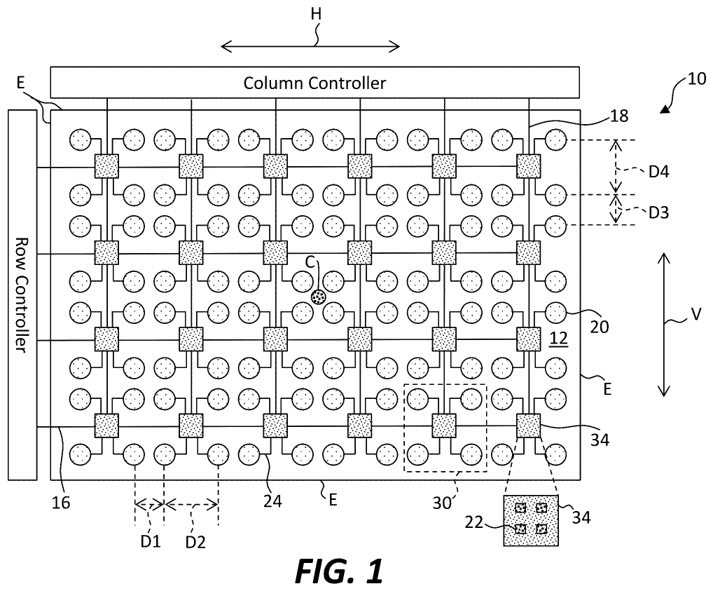

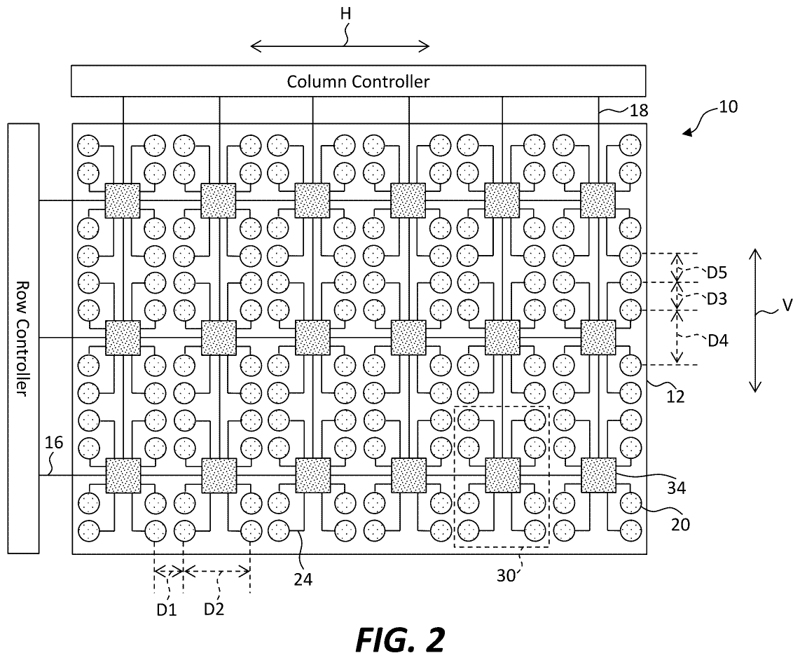

According to some embodiments of the present disclosure and as shown in FIGS. 1 and 2, a variable-resolution display 10 (a display 10) can comprise a display substrate 12 having edges (sides) E and a center C and display pixels 20 (pixels 20) disposed on display substrate 12. Variable-resolution display 10 and pixels 20 comprise pixels 20 that have a variable spatial resolution (a variable resolution) over display substrate 12. The variable resolution can be in a single direction (e.g., a dimension) or in two directions (e.g., two dimensions). In some embodiments, first pixels 20 in a first direction are separated by a fixed (regular) first distance and second pixels 20 in a second direction different from the first direction (e.g., an orthogonal direction) are separated by a fixed (regular) second distance different from the first distance.

Pixels 20 of variable-resolution display 10 distributed over display substrate 12 can be separated by different amounts (different distances) in a direction (e.g., a horizontal direction H or vertical direction V parallel to a surface of display substrate 12 such as an x or y dimension) so that pixel 20 spatial resolutions (separation distances) can vary in the direction and are disposed with variable spatial resolution in the direction. In such a variable-resolution display 10 pixels 20 are not spatially arranged over display substrate 12 in a completely regular array in which all pixels 20 are separated by the same separation distance but are spatially arranged over display substrate 12 in at least a partially irregular spatial arrangement (e.g., in two different regular arrangements). An irregular arrangement is an arrangement that is not completely spatially regular for all of pixels 20 over display substrate 12 so that at least two pixels 20 are separated by a first distance, for example D1, and two other pixels 20 are separated by a second distance, for example D2, that is different from the first distance D1 in a single, common direction or in two different directions. In some embodiments, pixels 20 have an irregular arrangement and are separated by different distances in each of two orthogonal directions (e.g., horizontal direction H and vertical direction V) so that pixels 20 disposed along a second direction orthogonal to the first direction are disposed with variable spatial resolution in multiple directions.

In some embodiments, a spatial resolution can be determined by using a point in a pixel 20 (e.g., a center of a pixel 20 or a center of a subpixel of a pixel 20) and measuring distance to equivalent point(s) in one or more other pixels 20 (e.g., an adjacent pixel 20). In some embodiments, a spatial resolution can be determined using a pitch of pixels 20 (e.g., pixels that emit a same color of light). In some embodiments, a spatial resolution can be determined using a pitch of subpixels in pixels 20 (e.g., pitch of subpixels that emit a same color of light). A spatial resolution can be determined over more than two pixels, for example to determine a resolution that represents an average value (e.g., over multiple pairs of adjacent pixels). In some embodiments, a spatial resolution is fixed along a direction (e.g., along a column of pixels 20 or along a row of pixels 20, or both). In some embodiments, a spatial resolution varies along a direction (e.g., along a column of pixels 20 or along a row of pixels 20, or both). A spatial resolution can be determined using and/or for pixels 20 that emit a same color of light. A spatial resolution can be determined using and/or for subpixels that emit a same color of light where the subpixels are in pixels 20 that emit multiple different colors of light (e.g., that include a red, a green, and a blue subpixel) (e.g., each of a plurality of subpixels in a pixel 20 emits a distinct color of light). Adjacent pixels 20 used to determine a spatial resolution can be pixels 20 that emit a same color of light. Adjacent subpixels used to determine a spatial resolution can be subpixels that emit a same color of light.

In some embodiments, pixels 20 in variable resolution display 10 are separated by two alternating distances in a direction, for example a first pixel 20 separated from a second pixel 20 adjacent to the first pixel 20 by a first distance in the direction, the second pixel 20 adjacent to and separated from a third pixel 20 by a second distance different from the first distance in the direction, the third pixel 20 adjacent to and separated from a fourth pixel 20 by the first distance in the direction, the fourth pixel 20 adjacent to and separated from a fifth pixel 20 by the second distance in the direction, and so on. The first, second, third, fourth, and fifth pixels 20 can be disposed in a line, for example spatially in order along the line. (The location of pixels 20 can be a center or edge of the pixels 20 and distances from a pixel 20 can be taken from the center or edge of the pixel.)

In some embodiments of the present disclosure, variable-resolution display 10 comprises pixels 20 including a first pixel 20, a second pixel 20, and a third pixel 20. First pixel 20 and second pixel 20 are adjacent and separated by a first distance in a first direction. First pixel 20 and third pixel 20 can be adjacent and separated by a second distance in a direction parallel to the first direction (e.g., in a common line). The first distance can be less than the second distance (e.g., at least 20% less, at least 25%, at least 40%, at least 50% less, at least 60% less, or at least 75% less). In some embodiments, variable-resolution display 10 can comprise pixels 20 including a first pixel 20, a second pixel 20, and a third pixel 20. First pixel 20 and second pixel 20 can be adjacent and separated by a first distance in a first direction. First pixel 20 and third pixel 20 can be adjacent and separated by a second distance in a second direction non-parallel (e.g., orthogonal) to the first direction. The first distance can be less than the second distance (e.g., at least 20% less, at least 25%, at least 40%, at least 50% less, at least 60% less, or at least 75% less). In some embodiments, multiple clusters 30 can each comprise an exclusive subset of pixels 20 in variable-resolution display 10. Pixels 20 can be exclusively connected to and controlled by a cluster controller 34 in each cluster 30. Cluster controller 34 can control multiple pixels 20 and can comprise multiple pixel controllers 22, for example one pixel controller 22 for each pixel 20 in cluster 30, especially where pixels 20 are active-matrix pixels 20, as shown in the detail of FIG. 1. In some embodiments, cluster controller 34 can provide passive-matrix control to pixels 20 in cluster 30.

As shown in FIGS. 1 and 2, two adjacent pixels 20 are separated by a separation distance D1 in a horizontal direction H (an x direction) and two adjacent pixels 20 are separated by a separation distance D2 different from separation distance D1 in the same horizontal direction H. Similarly, two adjacent pixels 20 can be separated by a separation distance D3 in a vertical direction V (a y direction) and two adjacent pixels 20 can be separated by a separation distance D4 different from separation distance D1 in the same vertical direction V. For embodiments in which pixels 20 are disposed in two (orthogonal) dimensions, pixels 20 can comprise at least five or more pixels 20 (e.g., three pixels 20 in each dimension with one shared pixel 20). Thus, in some embodiments, at least a first pixel 20 is closer to a second pixel 20 than to a third pixel 20 in a first direction. In some embodiments, at least a fourth pixel 20 is closer to a fifth pixel 20 than to a sixth pixel 20 in a second direction different from, e.g., orthogonal to, the first direction. One of the first, second, or third pixels 20 can be the same as one of the fourth, fifth, or sixth pixels 20. In some embodiments, pixels 20 comprise no fewer than 9, 16, 25, 100, 400, 900, 1600, 2500, 5625, or 10000 pixels 20. In some embodiments, pixels 20 are arranged in rows having no fewer than 3, 5, 10, 25, 100, 200, 300, 400, or 500 pixels 20 in each row. In some embodiments, pixels 20 are arranged in columns having no fewer than 3, 5, 10, 25, 100, 200, 300, 400, or 500 pixels 20 in each column. In some embodiments, pixels 20 are arranged in both rows and columns and have variable separation distances in a row direction (e.g., horizontal direction) and have variable separation in a column direction orthogonal to the row direction (e.g., vertical direction V). Variable-resolution display can have the same number of pixels 20 in rows as in columns. Pixels 20 can be arranged regularly in one of the first and second directions or can be arranged irregularly in both the first and second directions. First and second directions can be horizontal and vertical directions or x and y directions, for example both parallel to a surface of display substrate 12 on which pixels 20 are disposed.

In embodiments, despite the irregular arrangement of at least some pixels 20 in at least one direction, variable-resolution display 10 displays a single image comprising data for each pixel 20 and each pixel 20 is substantially similarly controlled, albeit with different pixel data, to display the single image. Thus, in embodiments, pixels 20 are functionally substantially similar or the same, operate substantially similarly or the same in response to pixel data, for example the same or similar pixel data, and provide substantially a similar or same function, e.g., displaying image data, where the image data comprises pixel data for each pixel 20 in an image displayed on variable-resolution display 10. In embodiments, pixel data in an image can comprise a different or same value for any pixels 20 displayed on variable-resolution display 10.

According to embodiments of the present disclosure, all of pixels 20 are controlled to emit light in response to a single constant image frame for a frame period of time, for example using pixel controllers 22 or cluster controllers 34. Different images can be displayed with pixels 20 of variable-resolution display 10 during different frame periods, for example successive frame periods as in a video or film. Successive frame periods can have a constant duration, e.g., the frame periods can all have the same temporal duration (can take or extend over the same time). In some embodiments, the frame periods all have at least a minimum temporal duration, for example a time required to update (display) all of pixels 20 in variable-resolution display 10 or a time required to store image data for all of pixels 20, e.g., stored in a frame store associated with or comprised in variable-resolution display 10, stored in a memory in cluster controllers 30, or stored in a memory in pixel controllers 22. In some embodiments, the frame periods have variable temporal duration but all are at least no less than the minimum temporal duration.

A single image frame comprises pixel data displayed for a frame period during which each pixel 20 in variable-resolution display 10 emits light corresponding to a pixel value of the single constant image frame. The pixel data (pixel value) displayed by each pixel 20 during the frame period does not change (although the actual control of pixels 20 can require that light is emitted for only a portion of the frame period, for example with passive-matrix pixel 20 control in which pixels 20 are controlled to emit light in successive rows or with active-matrix control pixels 20 in which the data supplied to each pixel 20 is updated by or stored in successive rows). In embodiments, a complete image comprising a value for each pixel 20 or subpixel 21 is stored in variable-resolution display 10 in each frame period and each pixel 20 or subpixel 21 is controlled to emit light for the value corresponding to pixel 20 or subpixel 21 in each frame period, even if the value in a frame period is no different from a value in a prior frame period.

In embodiments, the image frame data (the picture, image, pixel values, or pixel data) supplied to variable-resolution display 10 and cluster controllers 34 or pixel controllers 22 does not change during the frame period. The frame period is defined as the temporal period during which the image frame data does not change. Thus, pixels 20 can be controlled to emit light in response to an unchanging, constant image frame comprising an image pixel value for each pixel 20 during a temporal frame period.

FIG. 1 illustrates embodiments in which the relatively larger separation distances D2, D4 between adjacent pixels 20 in cluster 30 are equal in both horizontal and vertical directions H, V, respectively, and the relatively smaller separation distances D1, D3 between adjacent pixels 20 in adjacent clusters 30 are equal in both horizontal and vertical directions H, V, respectively. FIG. 2 illustrates embodiments in which the horizontal separation distance D2 between some of the adjacent pixels 20 in cluster 30 is greater than the horizontal separation distance D1 between adjacent pixels 20 in adjacent clusters 30. The vertical separation distance between different adjacent pixels 20 in a single cluster 30 is variable (as shown with different separation distances D3 and D4), and the vertical separation distance D5 between adjacent pixels 20 in adjacent clusters 30 is equal to (but does not necessarily have to be equal to) the shorter vertical separation distance D3 between adjacent pixels 20 in cluster 30. In general, the horizontal separation distance between adjacent pixels 20 in a cluster 30 can be different (e.g., variable) or the same, the vertical separation distance between adjacent pixels 20 in a cluster 30 can be different (e.g., variable) or the same, the horizontal separation distance between adjacent pixels 20 in adjacent clusters 30 can be different (e.g., variable) or the same, the vertical separation distance between adjacent pixels 20 in adjacent clusters 30 can be different (e.g., variable) or the same, the horizontal separation distance between adjacent pixels 20 in a cluster 30 can be different from the horizontal separation between adjacent pixels 20 in adjacent clusters 30, and the vertical separation distance between adjacent pixels 20 in a cluster 30 can be different from the vertical separation between adjacent pixels 20 in adjacent clusters 30, or any compatible combination of these.

Adjacent pixels 20 are two pixels 20 between which there are no other pixels 20 in a direction, e.g., a horizontal or a vertical direction H, V. Adjacent clusters 30 are two clusters 30 between which there are no other clusters 30 in a direction, e.g., a horizontal or a vertical direction H, V. The horizontal direction H can be orthogonal to the vertical direction V. In some embodiments, the separation distances D1 and D2 in horizontal direction H can be the same as the separation distances D3 and D4 in vertical direction V. In some embodiments, the separation distances D1 and D2 in horizontal direction H can be different from the separation distances D3 and D4 in vertical direction V. Pixels 20 separated by distance D1 can have one pixel 20 in common with pixels 20 separated by distance D2 (as illustrated in FIGS. 1 and 2) or can have no pixels 20 in common.

In some embodiments, pixels 20 are arranged in two orthogonal directions and are spatially arranged in an irregular arrangement in at least one direction. In some embodiments, pixels 20 are arranged in two orthogonal directions and are spatially arranged in an irregular arrangement in both orthogonal directions.

Pixels 20 can be active-matrix pixels 20 or passive-matrix pixels 20. In some embodiments, exclusive groups of pixels 20 are disposed in a cluster 30 of pixels 20 that can all be controlled by a common cluster controller 34, e.g., providing active-matrix or passive-matrix pixel control to pixels 20 in cluster 30. Rows of cluster controllers 34 can be connected in common to a display row wire 16 and columns of cluster controllers 34 can be connected in common to a display column wire 18. A row controller can provide row-control signals to cluster controllers 34 on display row wires 16 and a column controller can provide column-data signals to cluster controllers 34 on display column wires 18. Cluster controllers 34 can generate pixel control signals (either active-matrix or passive-matrix) to individual pixels 20 in cluster 30.

Clusters 30 can be arranged in a regular array over display substrate 12 or clusters 30 can be arranged in an irregular arrangement over display substrate 12. In some embodiments, cluster controllers 34 can be arranged in a regular array on or over display substrate 12. In some embodiments, cluster controllers 34 are not arranged in a regular array on or over display substrate 12. In some embodiments, pixels 20 in a cluster 30 can be arranged in a regular array over display substrate 12. In some embodiments, pixels 20 in a cluster 30 can be irregularly arranged over display substrate 12.

Display row wires 16 and display column wires 18 can be connected to an external display controller (not separately shown as an individual element in the Figures but, for example, comprising a row controller and a column controller, as shown) that provides display control signals to each cluster controller 34 or pixel controller 22, for example providing row-select signals and column-data signals, respectively. The signals received by each cluster controller 34 can be used by cluster controller 34 to control pixels 20 in cluster 30 comprising cluster controller 34 and pixels 20.

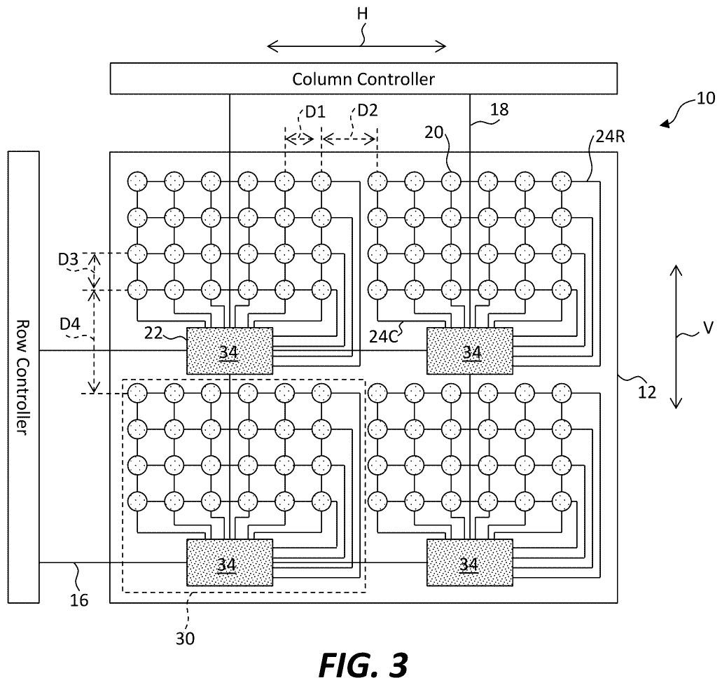

As shown in FIGS. 1 and 2, cluster controller 34 of each cluster 30 can provide active-matrix control to pixels 20 in cluster 30 or can provide passive-matrix control to pixels 20 in cluster 30. FIG. 3 illustrates embodiments in which cluster controller 34 of each cluster 30 provides passive-matrix control to each pixel 20 in cluster 30. Each pixel 20 in a cluster 30 can be connected in a row by a cluster row wire 24R to cluster controller 34 and each pixel 20 can be connected in a column by a cluster column wire 24C to cluster controller 34. Cluster controller 34 can comprise a cluster row controller for providing row-select signals to pixels 20 on cluster row wires 24R and a cluster column controller for providing column-data signals to pixels 20 on cluster column wires 24C (not shown in FIG. 3). Cluster controller 34 in cluster 30 can receive row-select signals and column-data signals on display row wires 16 and display column wires 18, respectively, from a display controller (not separately shown in the Figures) comprising a row controller and a column controller. In a cluster 30 (or in all of clusters 30), pixels 20 can be functionally substantially similar or the same, can operate substantially similarly or the same, and can provide substantially a similar or same function. Adjacent pixels 20 in a common cluster 30 can be spatially separated by a distance D1 different from a distance D2 between adjacent pixels 20 in different adjacent clusters 30 in one dimension (horizontal direction H) and can be spatially separated by a distance D3 in a cluster 30 different from a distance D4 between adjacent pixels 20 in different adjacent clusters 30 in a second, orthogonal direction (vertical direction V).

Display substrate 12 can be any useful substrate, for example as found in the integrated circuit or display industries, for example silicon, glass, plastic, or quartz. A display controller can be disposed on display substrate 12 or off display substrate 12, and can comprise one or more integrated circuits, for example a row-controller integrated circuit connected to display row wires 16 and a column-data controller integrated circuit connected to display column wires 18. In some embodiments, display substrate 12 is a semiconductor substrate 12, for example silicon, and cluster controllers 34 or pixel controllers 22 are native to (e.g., formed in or on) display substrate 12. In some embodiments, display substrate 12 is not a semiconductor substrate but is a dielectric substrate 12, for example glass or plastic, and cluster controllers 34 or pixel controllers 22 are formed in a thin-film layer on display substrate 12, for example with thin-film transistors. In some embodiments, display substrate 12 is not a semiconductor substrate but is a dielectric substrate 12, for example glass or plastic, and cluster controllers 34 or pixel controllers 22 are integrated circuits having a substrate separate and independent of display substrate 12 non-native to (e.g., separate and independent from or having separate and independent substrates) and disposed on display substrate 12, for example one or more silicon CMOS integrated circuits disposed on display substrate 12 by micro-transfer printing.

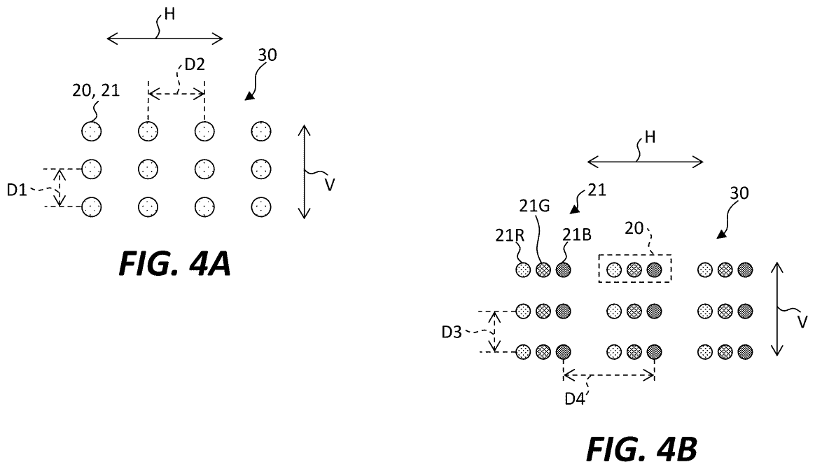

As shown in FIGS. 4A and 4B, pixels 20 can comprise one or more light-controllers, such as inorganic micro-light-emitting diodes 60 comprising a compound semiconductor material that each emit an amount of light that can be, but is not necessarily, different from the amount of light emitted by any other pixel 20. Each pixel 20 can be individually controlled to emit light corresponding to a pixel value in an image during an image frame period. Display row and display column wires 16, 18 and cluster row and cluster column wires 24R, 24C (collectively wires 24) can be formed on display substrate 12 (or an intermediate pixel substrate or cluster substrate) using photolithographic or inkjet methods and materials.

In some embodiments, the light-controllers can be disposed on display substrate 12 by micro-transfer printing. In some embodiments, the light-controllers can be disposed by micro-transfer printing light-controllers onto an intermediate pixel substrate or cluster substrate separate and independent from and disposed on display substrate 12. Similarly, cluster controller 34, if present, can be disposed on display substrate 12 by micro-transfer printing or can be disposed by micro-transfer printing onto an intermediate pixel or cluster substrate disposed on display substrate 12.

Pixels 20 can comprise monochrome pixels 20 that emit a single color of light or comprise color pixels 20 that emit multiple, different colors of light. In embodiments, monochrome pixels 20 can comprise a single light controller, for example a single light-emitting diode 60 that emits a single color, as shown in cluster 30 of monochrome pixels 20 in FIG. 4A that emit a same color of light and are separated by distance D1 in one vertical direction V and D2 in an orthogonal horizontal direction H. In some embodiments, pixels 20 are color pixels 20 that can comprise multiple subpixel light controllers, for example multiple light-emitting diodes 60 that can each be individually controlled and that can each emit a different color of light and provide a different communication channel, for example a red subpixel 21R that can emit red light, a green subpixel 21G that can emit green light, and a blue subpixel 21B that can emit blue light (collectively subpixels 21) as shown in cluster 30 of color pixels 20 in FIG. 4B.

Generally, a spatial separation distance D1 or D2 between adjacent pixels 20 in a direction (e.g., a horizontal or vertical direction H, V) can be the distance between light controllers in adjacent pixels 20 that emit the same color of light or can be the pitch of adjacent pixels 20 that emit the same color of light in the direction, where the pitch is the distance between centers of the light controller (e.g., centers of a light-emitting diode) in the direction, as shown in FIGS. 4A and 4B. A spatial separation between color pixels 20 is a spatial separation between subpixels 21 in adjacent pixels 20 that each emit the same color of light, as shown with distance D3 in FIG. 4B (e.g., either a pitch of or distance between subpixels 21 that emit a same color of light in adjacent pixels 20) in vertical direction V and distance D4 in orthogonal horizontal direction H. Color subpixels 21 in a pixel 20 can be arranged in a variety of ways, for example in a line as shown in FIG. 4B or in a triangular arrangement (where there are three subpixels 21 in pixel 20) or other arrangements.

FIGS. 1 and 2 illustrate embodiments of the present disclosure in which a cluster controller 34 can occupy significant area over display substrate 12 so that pixel 20 resolution around cluster controller 34 is less than pixel 20 resolution in display substrate 12 areas remote or away from cluster controllers 34. Thus, in some embodiments, variable-resolution display 10 has fewer display pixels 20 per unit area of display substrate 12 in a first region closer to a center C of display substrate 12 or of variable-resolution display 10 than to an edge E in a second region of display substrate 12 or of variable-resolution display 10, or vice versa. In some embodiments, pixels 20 in clusters 30 have fewer display pixels 20 per unit area in the second region of display substrate 12 than pixels 20 between clusters 30 of pixels 20 in the first region, or vice versa.

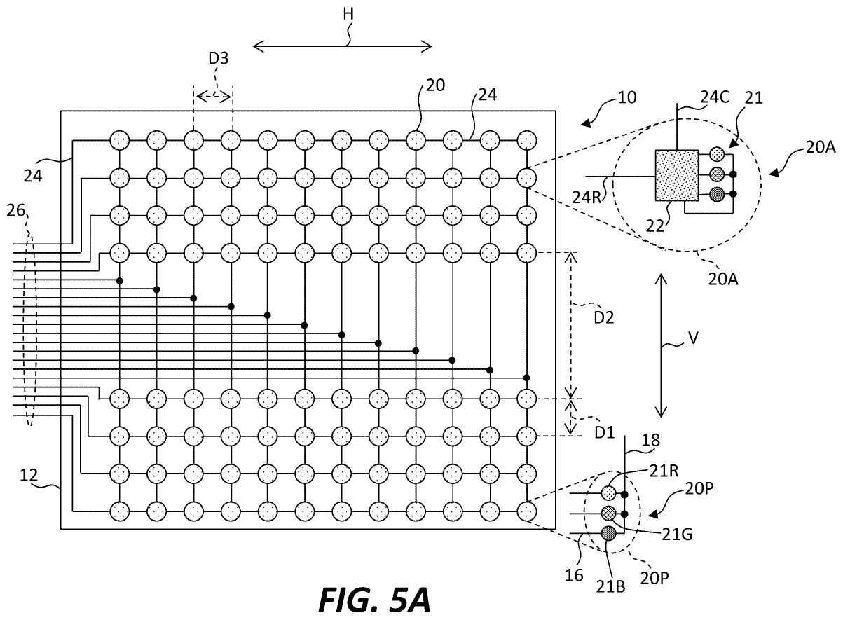

In some embodiments of the present disclosure and as shown in FIGS. 5A and 5B, physical structures other than controllers can occupy significant area over display substrate 12 so that variable pixel 20 resolution can increase the average density of pixels 20 over display substrate 12, increasing the optical communication bandwidth of variable-resolution display 10 with more pixels 20. As shown in FIGS. 5A and 5B, each active-matrix pixel 20A is provided with active-matrix control using a pixel controller 22, as shown in the upper detail or each passive-matrix pixel 20P is provided with passive-matrix control as shown in the lower detail, in response to external control signals, for example provided from an external display controller (not shown in FIGS. 5A and 5B) on wires 24 disposed on display substrate 12 that can extend from an edge E of display substrate 12 to a cluster controller 34 or pixel controller 22 of a pixel 20. (Active-matrix pixels 20A and passive-matrix pixels 20P are collective pixels 20 and either one or the other are typically exclusively used in variable-resolution display 10.)

Wires 24 (or buses 26 or connectors comprising wires 24) can require significant area on display substrate 12. In order to provide space for wires 24, separation distance D2 between adjacent pixels 20 can be larger where wires 24 are more densely provided than separation distance D1 between adjacent pixels 20 where wires 24 are less densely provided. As shown in FIG. 5A, the separation distance between adjacent pixels 20 in horizontal direction H is constant (not variable) and the separation distance between adjacent pixels 20 in vertical direction V is variable (not constant), as shown with different separation distances D1 and D2 between adjacent pixels 20.

In some embodiments, pixels 20 in clusters 30 have more display pixels 20 per unit area of display substrate 12 than pixels 20 between clusters 30 of pixels 20. In some embodiments, pixels 20 in clusters 30 or closer to a center C of display substrate 12 have more display pixels 20 per unit area of display substrate 12 than pixels 20 near an edge E of display substrate 12. In embodiments, display substrate 12 has edges E (e.g., two or more edges E or has a rectangular shape with four edges E) and fewer display pixels 20 per unit area of display substrate 12 are disposed at one of edges E than at another of the edges E or closer to a center of display substrate 12 or variable-resolution display 10.

As shown in FIG. 5A, the separation distance between adjacent pixels 20 in horizontal direction H is constant (not variable) and the separation distance between adjacent pixels 20 in vertical direction V is variable (not constant), as shown with different separation distances D1 and D2 between adjacent pixels 20. FIG. 5A illustrates embodiments with a single connector or bus 26 of wires 24 regularly distributed over a single contiguous portion of an edge E of display substrate 12. FIG. 5B illustrates embodiments with a multiple connectors or buses 26 of wires 24 distributed over different contiguous portions of an edge E of display substrate 12.

Such embodiments can be useful, for example, to reduce display bezel size on one or more sides of a display, for example locating all of the wire 24 connections on one side of display substrate 12. Wires 24 can be cluster row wires 24R and cluster column wires 24C (e.g., corresponding to passive-matrix display row wires 16 and display column wires 18) in a design that does not include separately controlled clusters 30, e.g., an active-matrix controlled variable-resolution display 10. FIGS. 5A and 5B also illustrate color pixels 20 having color subpixels 21 (e.g., as shown in FIG. 4B with red, green, and blue color subpixels 21R, 21G, and 21B). Each subpixel 21 can be connected with separate wires 24 (not shown in FIGS. 5A and 5B), taking even more space on display substrate 12.

In embodiments of the present disclosure, variation in pixel 20 spatial density on display substrate 12 can result from spacing requirements for both controllers (e.g., cluster controllers 30) and wires 24, as shown in FIG. 3. FIG. 3 illustrates pixel 20 spatial density variation at least due to cluster controllers 34 in vertical direction V and wires 24 in horizontal direction H. In general, pixel 20 variable spatial density over display substrate 12 can depend on either or both circuits (e.g., cluster or pixel controllers 34, 22) and wires 24, or indeed any other structure disposed over display substrate 12 in any direction.

In the Figures, the separation distances and sizes of cluster controllers 34, pixel controllers 22, and wires 24 are exaggerated for clarity of illustration and understanding.

Conventional displays can have a fixed pixel spatial resolution adapted to the human visual system and limited by control circuits (e.g., thin-film transistors) that control pixels 20 and wiring 24 that can require significant area and are not readily routed over display substrate 12. For example, a cluster controller 34 can occupy so much area over display substrate 12 that it inhibits the close disposition of pixels 20 in that area. In contrast, embodiments of the present disclosure provide increased data communication rates by providing more pixels 20 in variable-resolution display 10 that are used to communicate data with images rather than pictures. In such embodiments, the display is not necessarily viewed by a human observer and the constraints on displays designed for human observers (e.g., due to the human visual system) need not necessarily apply. In particular, humans generally prefer viewing a display with a fixed and consistent spatial resolution over its extent (e.g., over the area of a display substrate). In contrast to such a conventional display, according to embodiments of the present disclosure, a variable-resolution display 10 used for data communications (e.g., in a telecommunication or data center application) can communicate more data with more pixels 20 providing a greater bandwidth. Therefore, portions of display substrate 12 that are not used for control circuits (e.g., cluster controllers 34) or wiring 24 can be used for additional pixels 20 at a greater spatial density, thereby increasing the pixel spatial resolution in such areas. Stated inversely, areas of display substrate 12 used for circuits or wiring 24 can have fewer pixels 20 per area and reduced spatial resolution than other areas. (As used herein, a reduced, smaller, or lower pixel spatial resolution has fewer pixels 20 per area of display substrate 12 and an increased, greater, or higher pixel spatial resolution has more pixels 20 per area of display substrate 12.)

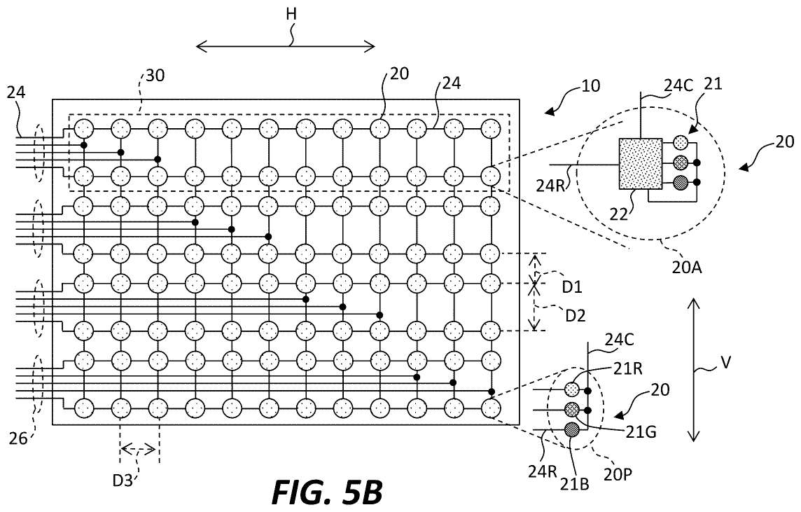

Each pixel 20 can include one or more light-emitters (e.g., a subpixel 21) such as micro-light-emitting diodes 60 that can be disposed on display substrate 12 by micro-transfer printing and can, in consequence, comprise a broken (e.g., fractured) or separated tether 70, as shown in FIGS. 6A and 6B for horizontal or vertical micro-LEDs 60, respectively. Similarly, any pixel controller 22 or cluster controller 34 can be disposed on display substrate 12 by micro-transfer printing and can, in consequence, comprise a broken (e.g., fractured) or separated tether 70, as shown in FIG. 6C.

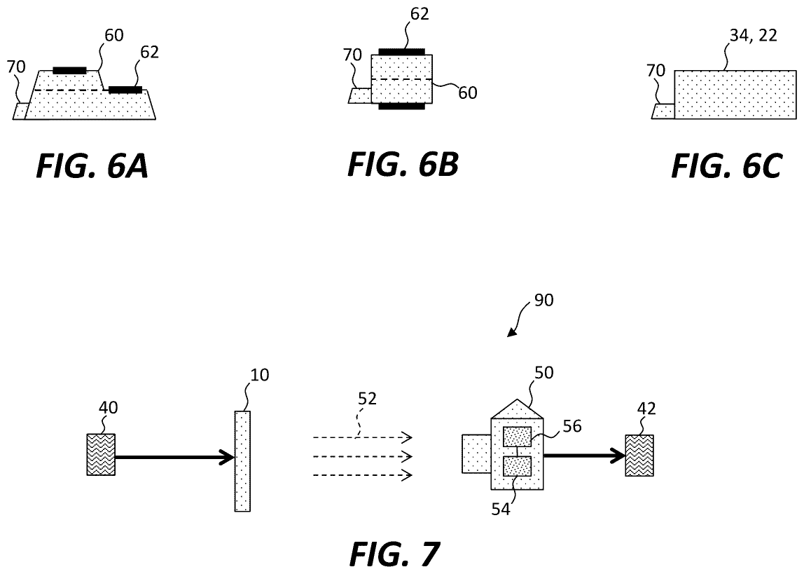

According to embodiments of the present disclosure, an optical communication system (e.g., a free-space optical communication system) 90 for transmitting optical data can comprise variable-resolution display 10 and a digital camera system comprising a digital camera 50 disposed relative to variable-resolution display 10 and a processor 54 (that can be integrated into or be a part of digital camera 50), as shown in FIG. 7, to communicate data, e.g., binary data, from images 40 displayed on variable-resolution display 10 to digital camera 50. Digital camera 50 can be operable to record image 40 displayed on variable-resolution display 10 and processor 54 connected to or a part of digital camera 50 can be operable to process the recorded image, forming processed image 42, to extract communicated data from the recorded image. The recorded image or processed image 42 (or both) can be stored in a memory 56 connected to processor 54 and disposed either internally or externally to digital camera 50.

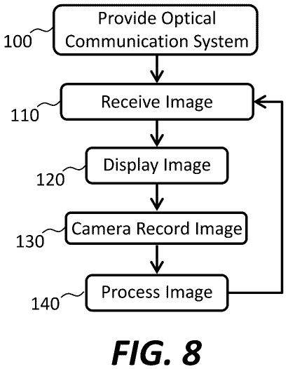

FIG. 8 is a flow diagram illustrating a communication method using variable-resolution display 10. In step 100, optical communication system 90, for example as shown in FIG. 7, is provided. An image 40 (e.g., a binary image 40) is received (e.g., from an external control system or display controller) in step 110 and displayed on variable-resolution display 10 using wires 24, cluster controllers 34 or pixel controllers 22, and pixels 20 (for example, as shown in FIGS. 1-3, 5A, 5B) in step 120. Digital camera 50 can record displayed image 40 in step 130 and process the recorded image in step 140 to make a processed image 42 and identify the communicated data.

In some embodiments, an optical communication system 90 can store or contain (e.g., in memory 56) a digital map of the pixel 20 locations on display substrate 12 to facilitate the recorded image processing (e.g., using pattern matching, convolutions or other algorithmic or mathematical methods to compare the digital map to the recorded image and locate pixels 20 in the recorded image) by processor 54 and identify pixels 20 in the recorded image to extract a value from each of the located pixels 20 in the processed image 42.

The data rate for optical communication system 90 is limited by the number of pixels 20 and the data rate at which images can be displayed on pixels 20. Therefore, by providing an increased number of pixels 20 with a variable resolution over display substrate 12, data can be communicated at a higher data rate, despite the presence of any pixel controllers 22, cluster controllers 34, and wires 24 disposed on display substrate 12 of variable-resolution display 10.

Digital camera 50 can comprise camera pixels that respond to light 52 transmitted from displayed image 40 on variable-resolution display 10 and exposed onto the camera pixels (e.g., imaged with an optical lens) and can be operable to capture and record the displayed image 40 exposed onto the camera pixels in a memory 56 in digital camera 50 or in a memory 56 external to digital camera 50. Digital camera 50 can process the recorded image stored in memory 56 with a processor 54, or a processor 54 external to digital camera 50 can process the recorded image, to provide a processed image 42.

Variable-resolution display 10 can be a multi-pixel display that optically emits light 52 from display pixels 20. Display pixels 20 can be disposed in any useful variable-resolution arrangement and can be captured by digital camera 50. Each image 40 displayed on variable-resolution display 10 is an image frame (e.g., frame) and the number of different received images 40 that can be displayed per unit of time by variable-resolution display 10 is the display frame rate. Variable-resolution display 10 can operate at higher frame rates with light emitters that can switch on and off faster, for example light-emitting diodes 60, and displayed images can be more readily detected by digital camera 50 with light emitters that are relatively bright, such as inorganic light emitters. In some embodiments, display pixels 20 of variable-resolution display 10 comprise inorganic light-emitting diodes 60 (iLEDs 60), for example horizontal inorganic micro-light-emitting diodes (micro-iLEDs 60) with electrodes 62 and fractured or separated tether 70, as shown in FIG. 6A or vertical micro-light-emitting diodes 60 with electrodes 62 and fractured or separated tether 70, as shown in FIG. 6B. Vertical micro-LEDs 60 can occupy less space over display substrate 12 (e.g., have a smaller footprint) and can be suitable for greater pixel 20 density variable-resolution displays 10 or in areas of display substrate 12 with greater display pixel 20 spatial density.

In some embodiments, display pixel 12 comprises or is a single light emitter (such as an iLED 60 for example emitting white light 52 or a color of light 52 such as green). In some embodiments, display pixel 12 is or comprises a group of light emitters (e.g., subpixels 21, for example each an iLED 60) that each emit a different color of light 52 and that are closer together or at least no farther apart than any two light emitters that emit the same color of light 52 in two different adjacent display pixels 12. Variable-resolution display 10 can be for example, a liquid crystal display, an electrophoretic display, an OLED display, or an iLED display; however, iLEDs 60 can provide faster switching times, brighter light 52, and improved efficiency compared to other display pixels 12 and, in some embodiments, variable-resolution display 10 is an iLED display 10. In some embodiments, variable-resolution display 10 is a color display 10 that emits different colors of light 52 from each display pixel 12. In some embodiments, variable-resolution display 10 is a black-and-white display 10 that emits white light 52. In some embodiments, variable-resolution display 10 emits only green light 52, only blue light 52, only infrared light 52, or only ultraviolet light 52. The color of light 52 emitted by variable-resolution display 10 can be a color that is most efficient for an iLED 60 to emit. (As used herein, light 52 refers to electromagnetic radiation that is emitted by variable-resolution display 10 or is captured by digital camera 50 and does not refer only to human-visible light.)

Digital camera 50 is any camera capable of digitally capturing and recording an image with an array of camera pixels, each camera pixel operable to record a portion of an image exposed onto the array of camera pixels, e.g., with an optical imaging system comprising one or more lenses. Digital camera 50 can have more camera pixels than variable-resolution display 10 has display pixels 20 so that digital camera 50 can record each of display pixels 20 with at least one and optionally multiple camera pixels. Digital camera 50 can be a black-and-white camera, can be responsive to only a single color of light 52, or can be a color digital camera 50 responsive to different colors of light 52 to record a color image. In some embodiments, the camera pixels each comprise a single light detector (such as a CCD or CMOS photodetector or light sensor) responsive to light 52 or a color of light 52. In some embodiments, the camera pixels each comprise multiple light detectors (such as CCD or CMOS photodetectors or light sensors) each responsive to a different color of light 52 (for example are exposed to light 52 through different color filters). In some embodiments, digital camera 50 detects only white light 52, only green light 52, only infrared light 52, only blue light 52, or only ultraviolet light 52 emitted from pixels 20 of variable-resolution display 10.

In some embodiments, digital camera 50 has an image capture (recording) frame rate equal to or greater than a display frame rate of variable-resolution display 10 (e.g., a camera frame rate equal to or faster than a display frame rate at which variable-resolution display 10 receives and displays images 40, e.g., one and a half or twice as fast). Digital camera 50 can be implemented with a state machine or computing circuits in digital camera 50 to capture and analyze the captured image, e.g., using image processing to form a processed image 42.

Optical communication system 90 can comprise a variable-resolution display 10 and digital camera system, for example each disposed on a printed circuit board and comprising digital integrated circuits, light-emitting diodes, light sensors, and optical components such as lenses for directing light 52.

In embodiments of the present disclosure, images can be binary images with display pixels 20 of variable-resolution display 10 that are either on or off. Such embodiments can be efficient if display pixels 20 comprise iLEDs 60 operated at a single desired current density. Similarly, digital camera 50 can be a black-and-white camera that provides a binary output in response to light exposure. Thus, in some embodiments, optical communication system 90 is a binary optical communication system 90. In some embodiments, each display pixel 20 and camera pixel can emit or respond to multiple different values, e.g., an eight-bit value, corresponding to a luminance of the pixel. In such embodiments, more information can be transmitted in each signal but with reduced signal-to-noise ratio.

Having described certain implementations of embodiments, it will now become apparent to one of skill in the art that other implementations incorporating the concepts of the disclosure may be used. Therefore, the disclosure should not be limited to certain implementations, but rather should be limited only by the spirit and scope of the following claims.

Throughout the description, where apparatus and systems are described as having, including, or comprising specific elements, or where processes and methods are described as having, including, or comprising specific steps, it is contemplated that, additionally, there are apparatus and systems of the disclosed technology that consist essentially of, or consist of, the recited elements, and that there are processes and methods according to the disclosed technology that consist essentially of, or consist of, the recited processing steps.

It should be understood that the order of steps or order for performing certain action is immaterial so long as operability is maintained. Moreover, two or more steps or actions in some circumstances can be conducted simultaneously. The disclosure has been described in detail with particular reference to certain embodiments thereof, but it will be understood that variations and modifications can be effected within the spirit and scope of the disclosure.

### PARTS LIST

C center
D1 first distance/separation distance
D2 second distance/separation distance
D3 third distance/separation distance
D4 fourth distance/separation distance
D5 fifth distance/separation distance
E edge
H horizontal direction
V vertical direction
10 variable-resolution display/display
12 display substrate
16 display row wire
18 display column wire
20 display pixel/pixel
20A active-matrix pixel
20P passive-matrix pixel
21 subpixel
21R red subpixel
21G green subpixel
21B blue subpixel
22 pixel controller
24 wire
24C cluster column wire
24R cluster row wire
26 bus
30 pixel cluster/cluster
34 cluster controller
40 received image/displayed image
42 processed image
50 digital camera
52 light
54 processor
56 memory
60 micro-LED/inorganic light-emitting diode/iLED
62 electrode
70 tether
90 optical communication system
100 provide optical communication system step
110 receive image step
120 display image step
130 camera record image step
140 process image step

1. A variable-resolution display, comprising:
a display substrate; and
pixels disposed on the display substrate,
wherein the pixels have a variable spatial resolution over the display substrate and are controllable to emit light in response to an unchanging image frame comprising data for each of the pixels during a temporal frame period.

2. The variable-resolution display of claim 1, wherein two adjacent ones of the pixels are separated by a first distance in a direction and two other adjacent pixels are separated by a second distance different from the first distance in the direction.

3-4. (canceled)

5. The variable-resolution display of claim 1, wherein (i) the pixels comprise a first pixel, a second pixel, and a third pixel, (ii) the first pixel and the second pixel are adjacent and separated by a first distance in a first direction, (iii) the first pixel and the third pixel are adjacent and separated by a second distance in a second direction parallel to the first direction, and (iv) the first distance is less than the second distance.

6. The variable-resolution display of claim 1, wherein the pixels comprise a first pixel, a second pixel, and a third pixel, the first pixel and the second pixel are adjacent and separated by a first distance in a first direction, the first pixel and the third pixel are adjacent and separated by a second distance in a second direction non-parallel to the first direction, and the first distance is less than the second distance.

7-9. (canceled)

10. The variable-resolution display of claim 1, wherein the pixels are connected in clusters and a spatial resolution of the pixels within each of the clusters is less than an average resolution of the pixels across the display substrate.

11. The variable-resolution display of claim 1, wherein fewer of the pixels per unit area of the display substrate are disposed in a first region than in a second region and wherein (i) the first region is closer to a center of the display substrate than to an edge of the display substrate and the second region is closer to the edge of the display substrate than to the center of the display substrate or (ii) the second region is at an edge of the display substrate and the first region is in a cluster of pixels away from the edge.

12. The variable-resolution display of claim 1, wherein fewer of the pixels per unit area of the display substrate are disposed in a second region than in a first region and wherein (i) the first region is closer to a center of the display substrate than to an edge of the display substrate and the second region is closer to the edge of the display substrate than to the center of the display substrate or (ii) the second region is at an edge of the display substrate and the first region is in a cluster of pixels away from the edge.

13. The variable-resolution display of claim 1, comprising a circuit disposed on the display substrate that is electrically connected to and controls two or more of the pixels.

14. The variable-resolution display of claim 13, wherein the circuit is a thin-film circuit native to the display substrate.

15. The variable-resolution display of claim 13, wherein the circuit is an integrated circuit comprising a circuit substrate non-native to the display substrate.

16. The variable-resolution display of claim 13, wherein the circuit is disposed in or on the display substrate in a region having a lower spatial resolution of pixels than another region of the display substrate.

17. The variable-resolution display of claim 13, wherein the display substrate has edges (e.g., two or more edges or has a rectangular shape with four edges) and fewer of the pixels per unit area of the display substrate are disposed at one of the edges than at another of the edges.

18. The variable-resolution display of claim 17, comprising a wire that extends from an edge of the display substrate to the circuit and is electrically connected to the circuit.

19. The variable-resolution display of claim 18, wherein the edge has fewer display pixels per unit area of the display substrate than another edge of the display substrate.

20. The variable-resolution display of claim 13, comprising a plurality of circuits, wherein each of the circuits is exclusively electrically connected to and controls an exclusive subset of the pixels.

21. The variable-resolution display of claim 1, wherein the pixels are monochrome pixels that each emit a same color of light.

22. The variable-resolution display of claim 1, wherein the pixels are color pixels comprising subpixels that each emit a different color of light.

23. The variable-resolution display of claim 1, wherein successive adjacent pixels along at least one direction are alternately separated by two different distances.

24. An optical communication system, comprising:
a variable-resolution display according to any one of the preceding claims; and
a camera system comprising a digital camera and a processor connected to the digital camera, wherein the digital camera is disposed relative to the variable-resolution display such that the digital camera is operable to record an image displayed on the variable-resolution display and the processor is operable to process the recorded image.

25. The optical communication system of claim 24, wherein the camera system comprises a memory connected to the processor and wherein a digital map of locations of the pixels on the display substrate is stored in the memory.

26-27. (canceled)
